(19) United States
(12) Patent Application Publication
(10) Pub. No.: US 2024/0232676 A9
(43) Pub. Date: Jul. 11, 2024

(54) Forecasting Information Technology and Environmental Impact on Key Performance Indicators

(71) Applicant: International Business Machines Corporation, Armonk, NY (US)

(72) Inventors: Avirup Saha, Kolkata (IN); Neelamadhav Gantayat, Bangalore (IN); Renuka Sindhgatta Rajan, Bangalore (IN); SAMPATH DECHU, Acton, MA (US); Ravi Shankar Arunachalam, Bangalore (IN); Kushal Mukherjee, New Delhi (IN)

(21) Appl. No.: 17/968,937

(22) Filed: Oct. 19, 2022

(51) Int. Cl. G06N 20/00

(52) U.S. Cl. CPC G06N 20/00

(57) ABSTRACT

Mechanisms are provided for forecasting information technology (IT) and environmental impacts on key performance indicators (KPIs). Machine learning (ML) computer model(s) are trained on historical data representing IT events and KPIs of organizational processes (OPs). The ML computer model(s) forecast IT events given KPIs, or KPI impact given IT events. Correlation graph data structure(s) are generated that map at least one of IT events to IT computing resources, or KPI impacts to OPs. The trained ML computer model(s) process input data to generate a forecast output that specifies at least one of a forecasted IT event or a KPI impact. The forecasted output is correlated with at least one of IT computing resource(s) or OP(s), at least by applying the correlation graph data structure(s) to the forecast output to generate a correlation output. A remedial action recommendation is generated based on the forecast output and correlation output.

### BACKGROUND

The present application relates generally to an improved data processing apparatus and method and more specifically to an improved computing tool and improved computing tool operations/functionality for automatically forecasting information technology (IT) and environment factor impacts on key performance indicators and recommending optimal remediations based on the forecasted impacts.

Key performance indicators (KPIs) are measurable values that determine how well an individual or organization is progressing towards their goals and objectives. Examples of KPIs may include, for example, number of orders processed, number of orders delivered, or other counts and/or statistical measures calculated from raw collected data. KPIs are used to monitor the health of a workflow and assist individuals at all levels of an organization to focus their work and efforts towards a common goal of the organization. While the organization and computing systems of an organization may gather many different measures, the KPIs are the key measurements used to determine if the organization is performing as desired and provides insights upon which decision making may be performed.

Many different computing tools have been developed for gathering data and generating/monitoring KPIs for various organizations. For example, IBM Sterling Supply Chain Insights™ with IBM Watson™, available from International Business Machines (IBM) Corporation of Armonk, New York, provides KPIs related to the health of a supply chain, covering areas of supply, sales orders, and delivery. Many of these computing tools have default sets of KPIs but also permit users to define their own custom KPIs for the particular individual, organization, or the like. Moreover, many of these systems provide graphical user interface outputs that allow users to view a representation of the current status of KPIs at a glance and receive alerts based on these KPIs and defined performance goals.

In addition, various computing systems have also been developed for monitoring performance of information technology (IT) systems, i.e., monitoring the operational state of the underlying data processing systems, computing devices, storage systems and devices, network systems and devices, software applications, and the like, collectively referred to as IT resources. For example, a storage system may be monitored with regard to available disk space and may generate warning events when the available disk space is determined to be low. Network bandwidth may be monitored by performance monitoring computer systems to determine when available bandwidth is being overutilized or underutilized and corresponding alerts may be generated. Such alerts may be triggered due to pre-determined IT service level agreements (SLAs), for example, and may then lead to the creation of incidents that are then resolved by IT teams in order to comply with the IT SLAs.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises executing machine learning training of one or more machine learning (ML) computer models based on historical data representing logged information technology (IT) events and key performance indicators (KPIs) of organizational processes. The one or more ML computer models are trained to forecast at least one of IT events given KPIs in input data, or KPI impact given IT events in the input data. The method further comprises generating at least one correlation graph data structure that maps at least one of IT events to IT computing resources, or KPI impacts to organizational processes. The method also comprises processing, by the one or more trained ML computer models, input data to generate a forecast output, wherein the forecast output specifies at least one of a forecasted IT event or a KPI impact. In addition, the method comprises correlating the forecasted output with at least one of one or more IT computing resources or one or more organizational processes, at least by applying the at least one correlation graph data structure to the forecast output to generate a correlation output. Furthermore, the method comprises generating a remedial action recommendation based on the forecast output and correlation output.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram illustrating the primary operational components of an organizational performance (OP) and information technology (IT) correlation based forecasting computer tool, referred to hereafter as the OP-IT forecasting computing system, during offline machine learning training in accordance with one illustrative embodiment;

FIG. 2 is an example diagram illustrating an example IT correlation graph in accordance with one illustrative embodiment;

FIG. 3 is an example diagram illustrating an example organizational process correlation graph in accordance with one illustrative embodiment;

FIG. 4 is an example block diagram illustrating the primary operational components of an OP-IT forecasting computing system during online operations in accordance with one illustrative embodiment;

FIG. 5 is an example diagram showing a correlation of OP operation metrics with IT events over time and the determination of a key performance indicator impact based on such a correlation, in accordance with one illustrative embodiment;

FIG. 6 is a flowchart outlining an example operation for performing offline training of the OP-IT forecasting computing system in accordance with one illustrative embodiment;

FIG. 7 is a flowchart outlining an example operation for performing online forecasting by way of the OP-IT forecasting computing system in accordance with one illustrative embodiment;

FIG. 8 is a flowchart outlining an example operation for performing remediation action planning based on forecasting from an OP-IT forecasting computing system in accordance with one illustrative embodiment; and

FIG. 9 is an example diagram of a distributed data processing system environment in which aspects of the illustrative embodiments may be implemented and at least some of the computer code involved in performing the inventive methods may be executed.

### DETAILED DESCRIPTION

While computing systems have been developed to monitor performance of an organization with regard to predefined key performance indicators (KPIs), and computing systems have been developed to monitoring the health and operation of information technology (IT) computing resources, these systems operate in silos, i.e., separate and disconnected from each other. There is currently no automated computing tool mechanism that facilitates an understanding of how the IT operations and issues in IT resources impact the organizational performance KPIs. That is, while IT teams may utilize computing tools to monitor the IT resources of an organization's computing and data storage environments, this monitoring and resolution of issues that the IT teams may be made aware of is separate and distinct from any monitoring of KPIs through corresponding KPI monitoring systems, which is more of an organizational performance concern than an IT concern. For example, while an IT team may receive alerts and resolve the corresponding incidents when the alerts are triggered, the IT team does not know the organizational performance impact of these IT alerts, or the potential corresponding organizational performance based incidents/problems that gave rise to the IT alerts, and thus, cannot prioritize the resolution of such issues based on the organizational performance impact, such as may be measured by KPIs. There is a disconnect between IT incident handling by IT teams and higher level organization or organizational performance level concerns measured by KPIs.

Thus, while IT monitoring systems may be able to prioritize alerts, such prioritization is performed with regard to predetermined service level agreements (SLAs) or computer resource performance criteria that does not reflect how IT problems impact KPIs, or how issues at the organizational performance level, such as those measured by KPIs, impact IT systems and resources. For example, IT monitoring systems and KPI monitoring systems cannot evaluate or forecast how, if hard disk storage is allowed to be left higher than a threshold, this would impact the organization's KPIs. As another example, IT monitoring systems and KPI monitoring systems cannot evaluate or forecast how, if IT teams took 6 hours to clear the disk space instead of 4 hours, this would impact the organization's KPIs. In yet another example, IT monitoring systems and KPI monitoring systems cannot evaluate how much organizational performance KPI impact was averted due to automated resolution of disk space issues. In short, there are no automated computing tools that can reason over IT monitoring metrics and KPI measurements and provide reliable forecasting of the impact of IT computing resource status on organizational performance KPIs, or vice versa, and automatically generate remedial action recommendations based on this forecasted impact.

The illustrative embodiments provide an improved computing tool with improved computer tool operations/functionality that automatically provides a causal and counterfactual impact analysis of organizational performance KPIs and IT alerts, incidents, metrics, affected computing resource information, and IT solution implementation data (referred to collectively as IT event related data), so as to correlate IT event related data for IT events (e.g., alerts, metrics having a predetermined relationship to SLA requirements or predetermined thresholds, or the like) with changes or impacts on KPIs, and vice versa. The improved computing tool and improved computing tool operations/functionality can automatically forecast when an IT event can occur and its impact on organizational performance, such as measured by predetermined KPIs. The improved computing tool and improved computing tool operations/functionality can forecast the organization process operations that are impacted by the IT events. The improved computing tool and improved computing tool operations/functionality can also form IT and organizational process (OP) operation forecasts to automatically generate and rank remediation recommendations for addressing the forecasted impacts on IT or OP operations, which in some cases may utilize counterfactual analysis to determine forecasted impacts and corresponding remediation operations, such as site reliability engineering (SRE) responses and remediation operations.

The improved computing tool and improved computing tool operations/functionality of the illustrative embodiments may train one or more machine learning computer models to recognize such correlations and predict or forecast the impact of an IT event on KPIs. This training of the machine learning computer model(s) is performed based on historical IT and organizational process (OP) operation event data, which may be collected by corresponding IT monitoring and KPI monitoring computer systems, as are generally known in the art. The historical IT and OP operation event data trains the machine learning (ML) computer model(s) to recognize patterns and correlations between IT events and KPIs so as to generate predictions or forecasts regarding future KPIs given IT events and trains the ML computer model(s) to predict or forecast IT events given a set of KPIs or changes in KPIs. In some illustrative embodiments, there is a first ML computer model that is trained on this historical IT and OP operation event data to generate predictions/forecasts of KPIs given one or more input IT events, and a second separate ML computer model that is trained on this historical IT and OP operation event data to generate predictions/forecasts of IT events given a set of KPI inputs or changes in KPIs.

These predictions/forecasts may be used with one or more correlation graph data structures to identify specific OP operations and IT resources impacted by the IT events or KPIs. For example, a first correlation graph data structure, referred to as the OP correlation graph, correlates different OP operations with corresponding KPIs. Thus, given a prediction/forecast of KPIs, corresponding OP operations affected by the predicted/forecasted KPIs may be identified. A second correlation graph data structure, referred to as the IT correlation graph, correlates an IT topology, i.e., the various IT computing resources, with corresponding IT events. Thus, given a prediction/forecast of IT events, corresponding IT computing resources affected by the predicted/forecasted IT events may be identified. It should be appreciated that the training of the ML computer models and the generation of the correlation graph data structures may be performed as one or more offline processes. The correlation graph data structures are generated by using causal models that learn, through machine learning and pattern matching operations, the relationships from a timeseries data of IT events, OP events and the KPIs.

Thus, based on the correlations learned in the historical IT and OP operation event data used to train the ML computer model(s), the trained ML computer model(s) may forecast IT events based on given KPIs or changes to KPIs, and can forecast KPIs, or changes to KPIs, based on the occurrence of IT events. In addition, the machine learning computer models may be used to generate predictions based on counterfactual analysis, i.e., exploring outcomes that have not actually occurred, but could have occurred under different conditions, e.g., what if the IT team did not correct the low disk space event of the storage system? How would this impact organizational performance as measured by KPIs? Moreover, a type of counterfactual analysis may also be performed assuming specific remedial actions, or interventions are performed, so as to predict/forecast the impact of these remedial actions or interventions on the KPIs and IT event forecasts.

These predications/forecasts may then be used with the correlation graph data structures to identify the impacted OP operations and IT computing resources. The impacted OP operations and IT computing resources may then be used as a basis to automatically identify remediation action recommendations and/or automatically initiate and execute remediation actions to mitigate predicted/forecasted unwanted KPIs, changes to KPIs, or IT events. In identifying these remediation actions, the mechanisms of the illustrative embodiments may perform a lookup operation in an IT resolution database, e.g. a SRE database of remedial actions, of remedial actions that address different KPI and/or IT events with regard to specific OP operations and IT computing resources. Moreover, these remedial actions may be correlated with SRE costs specified in an SRE database.

The predicted impact of the identified remedial actions, or interventions, may be generated using the trained ML computer models. Here the input to the ML model would be the simulated data resulting from a remedial action or an intervention. As the ML model would have learned from several interventions and remediations, the model predicts the impact of remediations based on the simulated input data. That is, predictions/forecasts of KPIs and IT events may be generated for specific remedial actions/interventions, e.g., such as an incident resolution, SRE remediation action, the time it takes to resolve the incident, or the like, identified based on the predicated KPIs, changes in KPIs, or IT events discussed above. Thus, the impact of performance of specific remedial actions (or interventions) on KPIs and IT events, as well as the impact of non-performance of remedial actions may be predicted/forecasted using the trained ML computer models and correlation graph data structures such that a predicted benefit of performing the specific remedial actions or interventions may be quantified.

The remedial action recommendations for the identified OP operation or IT computing resources and the predicated/forecasted IT events and/or KPIs may then be ranked based on a predicated impact of performing the remedial actions, such as may be determined from counterfactual analysis for example, and corresponding costs of the remedial actions. This ranking may balance the predicated impact and costs using a benefit-cost analysis tradeoff, for example.

Based on these predictions and counterfactual analysis, recommendations as to remedial actions may be automatically generated and output to appropriate authorized personnel, e.g., OP-level users or IT teams. As noted above, the remedial actions may be ranked relative to one another, where in some illustrative embodiments, this ranking may be based on a predicated KPI impact of the remedial actions and/or predicted cost of the remedial action, e.g., how much the remedial action will cost monetarily in terms of person time, downtime of resources, and the like. Moreover, in some cases, the remedial actions may be automatically initiated and executed to address the predicted IT/KPI issues based on the generated remedial action recommendations. The automatic initiation and execution of such remedial actions may be performed only with regard to remedial actions specified as being permitted to be performed automatically, and may be performed only with regard to one or more of the relatively highest ranked remedial actions in a ranked listing of remedial action recommendations.

While the specific operations for generating the remedial action recommendations will be described in greater detail hereafter, based on the predicted impacts of IT and KPI on each other using the trained machine learning computer models, it is helpful for understanding to discuss the types of outputs that illustrative embodiments may generate, so as to better understand the goal of the improved computing tool and improved computing tool operations/functionality. For example, with the mechanism of the illustrative embodiments, given current IT and OP operation events, determined through corresponding IT and KPI monitoring computing tools, in one example scenario in which a change in KPI is detected by the KPI monitoring computing tools, the improved computing tool of the illustrative embodiments may predict/forecast that the KPI of “Number of outbound shipping” will decrease by 100 within the next 2 hours. The mechanisms of the illustrative embodiments may generate remedial action recommendations of “try alternate route” and “slow down order creation.” Based on the operation the illustrative embodiments, the remedial action recommendation of “try alternate route” may be ranked higher than the “slow down order creation” based on a predicted KPI improvement of X %, e.g., 16%, and cost of $Y, e.g., $1000.00, compared to the predicted KPI improvement of M %, e.g., 1%, and cost of $Z, e.g., $100.00, for the “slow down order creation” remedial action recommendation. Thus, changes in KPI may be correlated with impacts of IT resources, such that remedial actions performed at the IT level can be used to address the issues associated with changes in KPI.

Similarly, in another example scenario, given current IT and organizational events, it may be determined that there is an IT event of “high disk usage”. The illustrative embodiments may generate remedial action recommendations, based on the correlation of impacts of KPI and IT events on each other, of “slow down order creation”, “create replica pod in OCP cluster 1”, and “increase memory and disk in OCP cluster 1”, which are ranked in this same order as ranks 1, 2, and 3, based on corresponding predicted KPI improvements and costs. For example, it may be determined that “slow down order creation” has a predicted improvement in KPI of 9% and a cost of $100, “create replica pod in OCP cluster 1” may have a predicted improvement in KPI of 12%, but the cost is $1000, and “increase memory and disk in OCP cluster 1” may have a predicted improvement in KPI of 10% and a cost of $1000. Based on the ranking criteria and logic, the tradeoff of improvement in KPI and cost may be evaluated to thereby rank the remedial action recommendations.

Based on the ranked recommendations, an output may be generated to appropriate authorized users to present the ranked recommendations and the predicated KPI impact and costs so as to facilitate decision making and focusing or prioritizing of organizational resources, e.g., IT and SRE teams, to address KPI/IT events that will have the most beneficial impact if resolved, and with the least cost. In some illustrative embodiments, highest ranking recommendations may be automatically initiated and executed if able, as discussed above. Criteria may be established for triggering automatic initiation and execution of such remedial actions, such as a required level of KPI improvement and costs below a predetermined threshold, for example.

Thus, the illustrative embodiments provide an improved computing tool and improved computing tool operations/functionality that specifically trains one or more machine learning computer models to predict/forecast KPIs, changes in KPIs, and IT events, and correlates these predictions with IT computing resources and organizational performance operations using correlation graph data structures to thereby forecast the impact of such KPIs, changes in KPIs, and IT events on an organization and its IT infrastructure. The illustrative embodiments provide automated computing tools to perform such predications and forecasts and identify remedial action recommendations to address unwanted impacts on the organization and its IT infrastructure. The illustrative embodiments provide automated computing tools to rank such remedial action recommendations and in some cases automatically initiate and execute the relatively highest ranking remedial action recommendations. Moreover, these operations are performed based on machine learning learned correlations between organizational performance operation metrics, such as KPIs, and underlying IT events. The ranking of remedial action recommendations takes into account the predicted benefit to the organization and its IT infrastructure versus the predicted costs so as to prioritize and focus organization and IT resources to those remedial actions that are of the most benefit with least cost.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described above, the illustrative embodiments of the present invention are specifically directed to an improved computing tool that automatically predicts/forecasts organization performance (OP) impacts and information technology (IT) architecture impacts of events based on a machine learning training of one or more machine learning models, correlation of such impacts with specific OP operations and IT computing resources, and automatically generates remedial action recommendations based on the correlations. It should be appreciated that these automated machine learning based operations that learn the correlations between IT events and organizational performance metrics such that given one type of event, the impact on the other may be predicated/forecast. All of the functions of the illustrative embodiments as described herein are intended to be performed using automated processes without human intervention. While a human being may benefit from the operation of the illustrative embodiments, the illustrative embodiments of the present invention are not directed to actions performed by the human being, but rather computer logic and functions performed specifically by the improved computing tool, including operation of specifically trained machine learning computer model(s) and the generation and application of correlation graph data structures to specifically identify impacted IT computer resources and OP operations, such as may be evaluated using key performance indicators (KPIs). While the illustrative embodiments may generate an output that ultimately assists human beings in performing decision making, the illustrative embodiments of the present invention are not directed to actions performed by the human being viewing the results of the processing performed by the improved computing tool, but rather to the specific operations performed by the specific improved computing tool of the present invention, which are operations that cannot be practically performed by human beings apart from the machine learning computer model mechanisms, correlation graph data structure and application logic, and other improved computing tool operations/functionality described herein. Thus, the illustrative embodiments are not organizing any human activity, are not simply implementing a mental process in a generic computing system, or the like, but are in fact directed to the improved and automated computer logic and improved computer functionality of an improved computing tool.

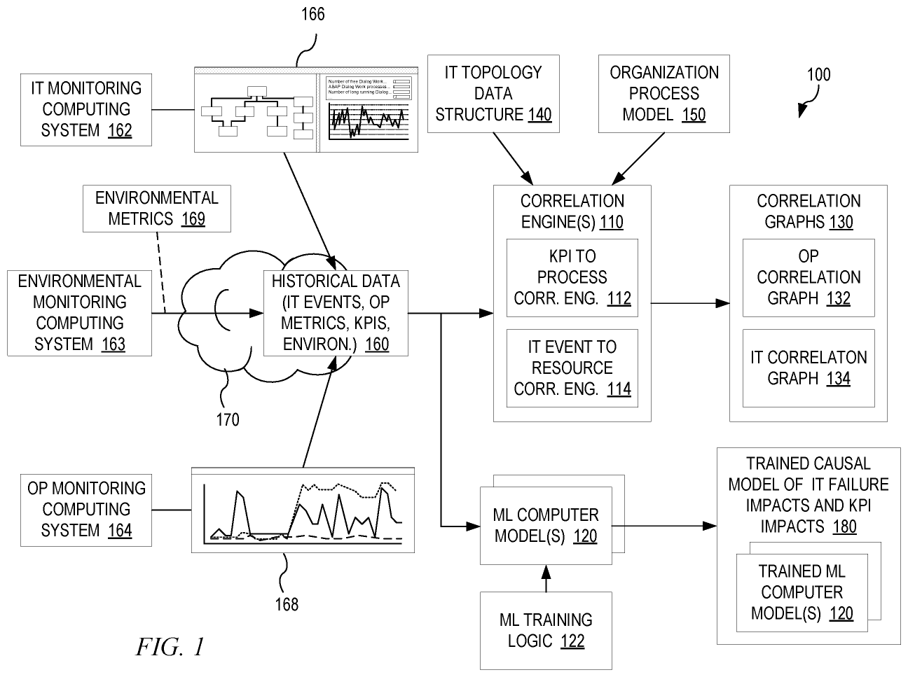

FIG. 1 is an example block diagram illustrating the primary operational components of an organizational performance (OP) and information technology (IT) correlation based forecasting computer tool, referred to hereafter as the OP-IT forecasting computing system, during offline machine learning training in accordance with one illustrative embodiment. It should be appreciated that the “offline” machine learning training is performed on historical operational performance (OP) and IT event data prior to online operation, where the OP-IT forecasting computer tool or computer system operates on runtime collected IT event, OP metrics, and key performance indicators (KPIs), such as may be collected by OP operations monitoring computing tools, IT performance and IT event monitoring computer tools, or the like. While an offline machine learning training is depicted in FIG. 1, it should be appreciated that in some illustrative embodiments, this training may be updated at later times based on recorded OP and IT event data so as to update the training of the machine learning computer model(s) based on observed OP and IT events, to potentially learn new correlations between OP and IT events, KPIs of OP operations and IT events, and the like.

As shown in FIG. 1, the OP-IT forecasting computing system or computer tool 100 comprises an OP-IT correlation engine 110 and one or more machine learning computer model(s) 120. The OP-IT correlation engine 110 and the one or more machine learning (ML) computer models 120 are trained based on historical data 160, which may comprise IT event data and OP event data, where the OP event data may comprise metrics which are then used to generate key performance indicators (KPIs) for the OP operations, systems, and the like. In addition, in some illustrative embodiments, the historical data 160 may comprise environmental metrics, such as temperature, humidity, power, and other metrics characterizing an operational environment of the IT computing resources and OP operations, e.g., weather may impact shipping operations of an organization and thus, various weather metrics may be impactful of KPIs and IT events.

The historical data 160 may be compiled and collected by various historical data source computing systems 162-164. For example, the historical data source computing systems 162-164 may comprise one or more IT monitoring and event alert generation computing systems 162 that monitor IT computing resources by measuring and collecting metrics, e.g., processor usage, storage usage, memory usage, network bandwidth, etc., and generates IT events, incidents, and/or alerts 166 based on the measured and collected IT metrics data. For example, if available storage space falls below a predefined threshold, an IT event and/or alert may be generated indicating “low storage availability” or the like. There are monitoring tools such as IBM Instana™ that collect the IT metrics data and can generate IT events based on user-defined policies of storage space or other IT resources.

The historical data source computing systems 162-164 may further include one or more organizational performance (OP) monitoring computer systems 164 that monitor key performance indicators (KPIs) for organizational level operations, where these KPIs may be based on raw metric data collected and used to calculate higher level KPIs according to predefined KPI definitions. For example, KPIs that may be used to monitor the health and performance of an organization may be of the type including number of orders processed within a given time period, number of orders delivered within a given time period, weekly average order cycle time, daily order processed amount, weekly order re-work rate, and the like. The OP monitoring computer systems 164 may report KPI data 168 for various organizational processes.

One example of an OP monitoring computer system 164 that may operate and provide a portion of the historical data 160 may be the IBM Process Mining™ computer tool available from International Business Machines (IBM) Corporation of Armonk, New York. IBM Process Mining™ is a process mining solution that automatically discovers, constantly monitors, and continuously optimizes the organizational processes. Process mining uses organizational system data to create and visualize an end-to-end process that includes all process activities involved along with various process paths. Other examples of OP monitoring computer systems 164 that may be utilized may include Business Process Operations (BPO) dashboards in System Analysis Program (SAP), available from SAP SE of Weinheim, Germany, or the like.

Another historical data source computing system 162-164 that may provide a portion of the historical data 160 may comprise one or more environmental monitoring computing systems 163 that monitor the various environments that may affect the organization's performance and/or IT computing resource operations. These environmental monitoring computer systems 163 may monitor computing environments of the IT computing resources, such as internal temperatures, power availability, and the like, of facilities in which the IT computing resources are located. These environmental monitoring computer systems 163 may also comprise external weather conditions, such as temperatures, precipitation, storm situations, power outages, and the like, which may be obtained from other weather reporting organizations and agencies, e.g., the national weather service (NWS) of the United States of America, or the like, through data feeds and the like. The environmental conditions data 169 generated by the environmental monitoring computer systems 163 may specify various metrics and corresponding temporal characteristics, e.g., timestamps, of when these metrics were measured as well as other information specifying locations where these metrics were measured and the like.

It should be appreciated that while these historical data source computing systems 162-164 are shown and described herein as examples, other historical data sources may provide other portions of historical data 160 in addition to, or in replacement of, portions of historical data provided by these historical data source computing systems 162-164. For example, social networking computer systems that may report notable events, news feed computing systems, transportation network monitoring computing systems, and the like, or any other suitable computing systems that monitor and report data representing conditions that may impact or influence organization performance operations, such as may be measured by predefined KPIs, and/or IT computing resource performance, such as may be measured by IT metrics, may operate as historical data sources providing portions of the historical data 160. For example, news feeds may provide data indicating power outages, weather events, political and/or social events that may impact operations, traffic conditions, and the like. Transportation network monitoring computing systems may report data indicating transportation pathway slowdowns, shutdowns, and the like, congestion at ports, and the like, which may all impact organization performance and corresponding KPIs.

It should be noted that the historical data 160 comprises IT and OP events, corresponding IT metrics, OP KPIs, and the like, that have corresponding temporal characteristic data such that cause-and-effect relationships may be evaluated and identified in the IT and OP events, IT metrics, and KPIs. That is, over a period of time, the correlation engine 110 may evaluate the historical data and generate correlation graphs 130 that correlate IT and OP events, IT metrics, and KPIs based on the temporal characteristics. For example, IT metrics may indicate an IT alert or event situation in which there is low processor availability during a particular temporal period, during that particular temporal period, there were certain batch job error rate alerts generated, and that at approximately a same time, one or more KPIs were below a given threshold, e.g., number of orders processed was below a predetermined threshold. Correlations between these historical data 160 may be determined by the correlation engine 110 to generate correlation graph data structures 130 for various ones, or combinations of, these portions of historical data 160.

The correlation engine 110 uses the historical data 160, such as event logs, metrics, KPIs, and the like, that are recorded in the historical data along with their corresponding temporal characteristics, and correlates this information with IT topology data structures 140 specifying the IT topology of the organization's IT infrastructure, and process model data structures 150 that specify the organization and hierarchy of organizational processes across the organization. To generate the KPI to process step correlation, the historical data of KPIs and OP metrics corresponding to different process steps are processed as time series data. Different statistical casual models used on this time series data to identify the causal relationship between the OP metrics corresponding to the process step and the KPIs. A similar approach of correlating the environmental event data with KPIs is used where casual models are applied to identify the relationship between the environmental factors and KPIs. For the IT metrics, the IT topology is used that provides information about the various IT metrics and errors associated with each IT resource. Hence, a causal relationship is derived between the IT errors and IT metrics with the resource based on the IT topology.

For example, the historical data 160 may be parsed and analyzed to identify instances of indicators in the logged events, indicators of processes corresponding to IT metrics and/or KPIs, and the like, that are indicative of particular IT topology elements and/or organizational processes that were involved in or otherwise affected the historical data 160 recorded events, incidents, alerts, etc., and the corresponding metrics, KPIs, and the like. These indicators may be correlated by the correlation engine 110 with IT computer resource indicators in the IT topology data structure 140 and organizational process indicators in the process model 150. In one illustrative embodiment, as depicted in FIG. 1, the correlation engine 110 comprises a first correlation engine 112 that correlates KPIs with organizational processes based on these input data structures 140-160, and a second correlation engine 114 that correlates IT events with underlying IT computing resources based on these input data structures 140-160. These correlation engines 112-114 may generate corresponding correlation graph data structures 130, and may combine correlations into one or more multi-dimensional correlation graph data structures in 130 that correlate KPIs with organization processes, with IT events, and IT computing resources.

The IT topology data structures 140 specify the IT computing resources, which may be hardware and/or software computing resources, their dependencies and relationships. The process model data structures 150 specify the organization processes, which are higher level processes representing operations and functions performed by portions of the organization at an organization level rather than the underlying IT computing resource level. For example, the IT topology data structures 140 may specify that one computing device communicates with another computing device, whereas the process model data structures 150 may specify that a process for creating an order has a dependent process hierarchy comprising a dependent process of validating the order, which has a dependent process for creating an outbound delivery, etc. The IT Topology data structure 140 can be discovered from IT monitoring tools such as IBM Instana™. Similarly, the Organization Process model 150 can be discovered from monitoring tools such as IBM Process Mining™ tool.

The historical data 160 is also input to train one or more machine learning (ML) computer models 120 to train these ML computer models 120 to perform prediction/forecasting of IT events given input KPIs, KPIs given IT events, and the like. For example, the IT events, and their corresponding characteristics or features, occurring within a given period of time may be input to a first ML computer model, i.e., an IT to KPI forecasting ML computer model 122, which then predicts/forecasts KPIs for the period of time given the input IT event characteristic/feature data. These predications/forecasts may be compared against the actual KPIs recorded in the historical data 160, which operate as a ground truth for the machine learning training. The differences between the predictions/forecasts and the actual recorded KPIs may be used to calculate a loss for the machine learning computer more, or an error. ML training logic 180 may be used to modify operational parameters of the ML computer model so as to reduce this loss, or error. For example, a stochastic-gradient-descent (SGD) based machine learning training, or other known or later developed machine learning training algorithm, may be used to modify the operational parameters of the machine learning computer model so as to reduce the loss/error. This process, which may be implemented as supervised or unsupervised machine learning operations, may be repeated for a predetermined number of iterations, or epochs, or until the loss satisfies a predetermine criteria, e.g., loss below a predetermined threshold.

In this way, the ML computer model 122 learns correlations between input patterns of IT event characteristics/features and corresponding KPIs. The input features that are input to the ML computer model 122 may, in some illustrative embodiments, include IT alert values, IT metrics values, relevant OP metrics, the time of the day, the day of the week, and various other such features, for example. Thus, after machine learning training is complete, the trained IT to KPI forecasting ML computer model 122 is able to predict or forecast, given a set of IT event characteristic data, the KPIs that may result within a given period of time.

A similar machine learning training may be performed with regard to a second ML computer model 124 that learns patterns of input KPIs and their characteristics/features, and IT events, incidents, or alerts. The second ML computer model 124, referred to as a KPI to IT forecasting ML computer model 122, may then, after having been trained through machine learning training by the machine learning training logic 180, predict/forecast IT events that are likely to occur given an input set of KPIs and/or KPI characteristics/features. Thus, with the ML computer models 120, the mechanisms of the illustrative embodiments are able to predict/forecast IT events and KPIs based on learned relationships between IT events with their characteristics/features, and KPIs with their characteristics/features.

With the machine learning training of the ML computer models 120, and the generation of the correlation graph data structures 130, these mechanisms may be applied to runtime data to predict/forecasted IT events/KPIs and correlate these with IT computing resources and organizational processes that are affected by the predicted/forecasted IT events/KPIs. That is, the predictions/forecasts output by the ML computer models 120 may be used with the correlation graph data structures 130 to identify specific OP operations and IT computing resources impacted by the IT events or KPIs. For example, a first correlation graph data structure 132, referred to as the OP correlation graph 132, may be used to correlate different organizational, or OP, operations with corresponding KPIs. Thus, given a prediction/forecast of KPIs, corresponding OP operations affected by the predicted/forecasted KPIs may be identified. A second correlation graph data structure 134, referred to as the IT correlation graph 134, correlates an IT topology 140, i.e., the various IT computing resources, with corresponding IT events. Thus, given a prediction/forecast of IT events, corresponding IT computing resources affected by the predicted/forecasted IT events may be identified.

Thus, based on the correlations learned based on the historical data 160 used to train the ML computer model(s) 120, the trained ML computer model(s) 120 may forecast IT events based on given KPIs or changes to KPIs, and can forecast KPIs, or changes to KPIs, based on the occurrence of IT events. In addition, as will be described hereafter with regard to runtime online operation, machine learning computer models may be used to generate predictions based on counterfactual analysis, i.e., exploring outcomes that have not actually occurred, but could have occurred under different conditions. This counterfactual analysis is done by changing the input to the model and then predicting the output. Here, for example, the input to the ML computer model(s) 120 may be manipulated to reflect the IT metrics coming back to normalcy (or below the thresholds) and then forecast the KPIs. The OP metrics data may also be changed, for example, change the pending orders to a low value, and the ML computer model(s) 120 may be used to predict the impact on the IT metrics.

In one or more illustrative embodiments, logic may be provided that generates alternative scenarios based on the predictions/forecasts generated by the ML computer model(s) 120 by extrapolating or projecting the predicted/forecasted conditions, e.g., KPIs, IT events, etc., for a period of time in the future. For example, a linear regression based projection may be used to assume that, if nothing is changed, i.e., no remediation actions are performed, then the predicted/forecasted conditions will continue along a linear projection into future time points. As discussed hereafter, this may be compared to predictions/forecasts should remedial actions be implemented to address the predicted/forecasted IT events, KPIs, etc. so as to determine the impact of remedial actions on KPIs and IT events, which may be used as a factor in ranking remedial action recommendations, for example. In this way, the ML computer models 120 may be used to simulate conditions for counterfactual analysis and evaluation of remedial action recommendations.

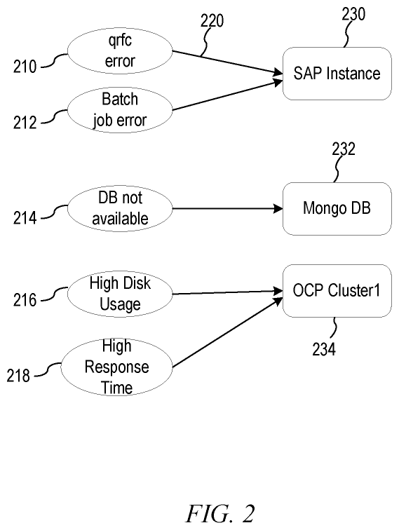

As noted previously, the predictions/forecasts generated by the ML computer models 120 are used as a basis for performing correlations by applying the correlation graph data structures 130 to the predictions/forecasts. In this way, the affected IT computing resources and/or organizational processes may be identified given the predicted/forecasted IT event/KPI conditions. FIG. 2 is an example diagram illustrating an example IT correlation graph in accordance with one illustrative embodiment. As shown in FIG. 2, the IT correlation graph 200, which may be represented as elements of an IT correlation graph data structure 134 in FIG. 1, for example, comprises nodes 210-218 corresponding to IT events, incidents, or alerts that are logged or otherwise represented in the historical data 160, and edges 220 connecting these IT events to corresponding nodes 230-234 representing IT computing resources. This graph uses the IT topology data 140 to identify the IT nodes that are associated to the IT events. A monitoring tool that captures the IT metrics also contains the information about the IT node where the alert is occurring. The information from the monitoring tool is used to create this IT topology data structure 140. However, in some cases, there can be transitive dependencies. For example, a high disk usage, can cause a database to not be available. Such relationships are captured by using the historical time series data of different IT metrics and capturing a causal relationship between IT metrics. The IT correlation graph 200 may be generated by the correlation engine 114 that maps indicators of IT events with IT computing resources specified in the IT topology 140 based on indicators in the logs and other historical data 160 specifying locations of the IT events, temporal characteristics, and the like.

Thus, for example, the depicted IT correlation graph 200 correlates IT events, incidents, or alerts, of “high disk usage” (node 216) and “high response time” (node 218) with the IT computing resource OpenShift Container Platform (OCP) cluster 1 (node 234). Similarly, nodes 210-212 are mapped to the SAP instance represented by node 230 and node 214 is mapped to Mongo Database (DB) represented by node 232.

The IT correlation graph 200 maps each IT event and its characteristics to one or more corresponding IT computing resources. Thus, when new data is received representing IT events, such as predictions/forecasts generated by the trained ML computer models 120 of the illustrative embodiments, then these IT events may be matched to one or more matching nodes 210-218 and a measurement of correlation may be generated. Thus, for example, various characteristics of the predicted/forecasted IT event may be compared to characteristics of mapped IT events, e.g., an IT event may involve multiple error conditions, IT resource conditions, or the like, which may be characteristics used to compare to the IT correlation graph 200, to thereby generate a measure of correlation and identify the most likely portions of the IT correlation graph 200 that match the predicted/forecasted IT event(s). This will identify which IT computing resources are most likely to be affected by the IT event.

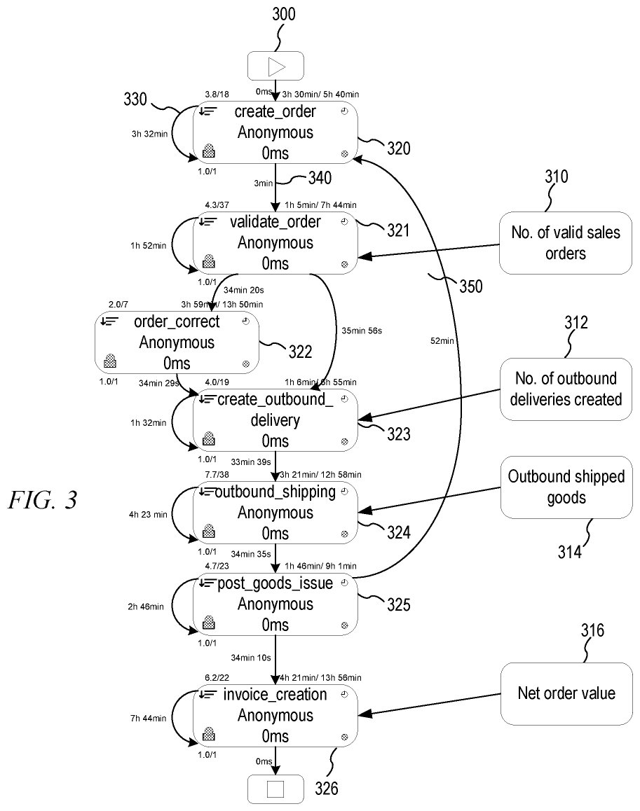

Similar operations may be performed with regard to the organizational process correlation graph, but with some modifications due to the different way in which the organizational process correlation graph represents organizational processes. FIG. 3 is an example diagram illustrating an example organizational process correlation graph in accordance with one illustrative embodiment, which can be represented by a data structure, such as organizational process correlation graph data structure 132 in FIG. 1. As shown in FIG. 3, elements of the organizational process correlation graph 300 include nodes 320-326 representing sub-processes of an overall process 320, where there may be a separate organizational process correlation graph 300 for each overall process 320 that the organization monitors. Edges 350 between the nodes 320-326 represent the dependencies, calling capabilities, and/or data communication pathways between sub-processes, e.g., the sub-process “post_goods_issue” represented by node 325 may return data to the sub-process “create_order” represented by node 320 as indicated by edge 350.

Edges may also exist from a node to itself to thereby represent execution time of the corresponding sub-process. For example, edge 330 goes from node 320 back to node 320 representing that the “create_order” sub-process takes 3 hours and 32 minutes. The nodes 320-326 and edges 330-350 have corresponding characteristics or features including temporal characteristics specifying the amount of time that the process requires to perform an associated operation. The combination of nodes and edges represents an end-to-end organizational process with all its sub-processes, their dependencies and communication pathways, and temporal characteristics.

As shown in FIG. 3, in addition to the nodes 320-326 and edges 330-350, nodes 310-316 are also provided that represent the various KPIs, where these nodes are linked through corresponding edges to the particular sub-processes with which the KPIs are associated. For example, node 310 represents a KPI of “No. of valid sales orders” which is associated with the sub-process “validate_order” represented by node 321. Similarly, the KPI “No of outbound deliveries created” (node 312) is associated with the sub-process “create_outbound_delivery” represented by node 323. As another example, the KPI “Net order value” (node 316) is associated with the sub-process “invoice_creation” represented by node 326.

Thus, the organizational process correlation graph 300 correlates KPIs with corresponding processes and sub-processes. Hence, given a predicated/forecasted KPI, the processes and sub-processes that will be affected by the predicated/forecasted KPI may be identified through the mapping and correlation provided by the organizational process correlation graph 300, e.g., a predicted/forecasted change to KPI 312 in FIG. 3 shows that the process 320 is affected or may in some way be involved in the change to the KPI 312, as well as specifically sub-process 323. For example, if the number of outbound deliveries is predicted/forecasted to drop, then it can be determined that the create_outbound_delivery sub-process of the process 320 may be affected or may be a cause of this drop. To generate such a causal model, the OP metrics that are associated to each process step (for example the number of outbound shipping events is associated to the process step outbound_shipping) are obtained. Then, various observations may be made in the time series data, such as if it is observed that there is a high correlation between the OP metrics corresponding to the process step and the KPI “outbound shipped goods,” a causal relationship can be generated between the KPI and the process step. There could be many false positive relationships that can be discovered. Hence, additional causality detection algorithms are used where the time series data from the OP metrics and KPI are used to discover casual relationships.

Thus, through the training of the OP-IT forecasting computing system or computer tool 100 based on the historical data 160, IT topology 140, and process model 150, correlation graph data structures 130 and one or more ML computer models 120 are automatically generated to predict/forecast IT events, KPIs, and changes in KPIs, as well as correlate these predictions/forecasts with the particular organizational processes and sub-processes and IT computing resources that are affected by or otherwise are involved in the predicted/forecasted conditions, e.g., IT events, KPIs, or changes in KPIs. In particular, the correlation engines 112 and 114 operate on the historical data 160 and the IT topology 140 and process model 150 to generate the correlation graph data structures 130 mapping IT events to IT computing resources and KPIs to particular organizational processes and sub-processes (collectively referred to as processes in general). Moreover, machine learning training logic is applied to ML computer models 120 to train the one or more ML computer models 120 on the historical data 160, operating as training data and ground truth data, to identify patterns in input data and generate predictions/forecasts regarding the impact of the input data with regard to IT events and KPIs. Having trained these components of the OP-IT forecasting computing system or computer tool 100, the OP-IT forecasting computing system or computer tool 100 may be deployed for runtime, or online, operation based on newly collected data from source computing systems, e.g., 162-164, monitoring the various IT computing resources, environmental conditions, and organizational processes.

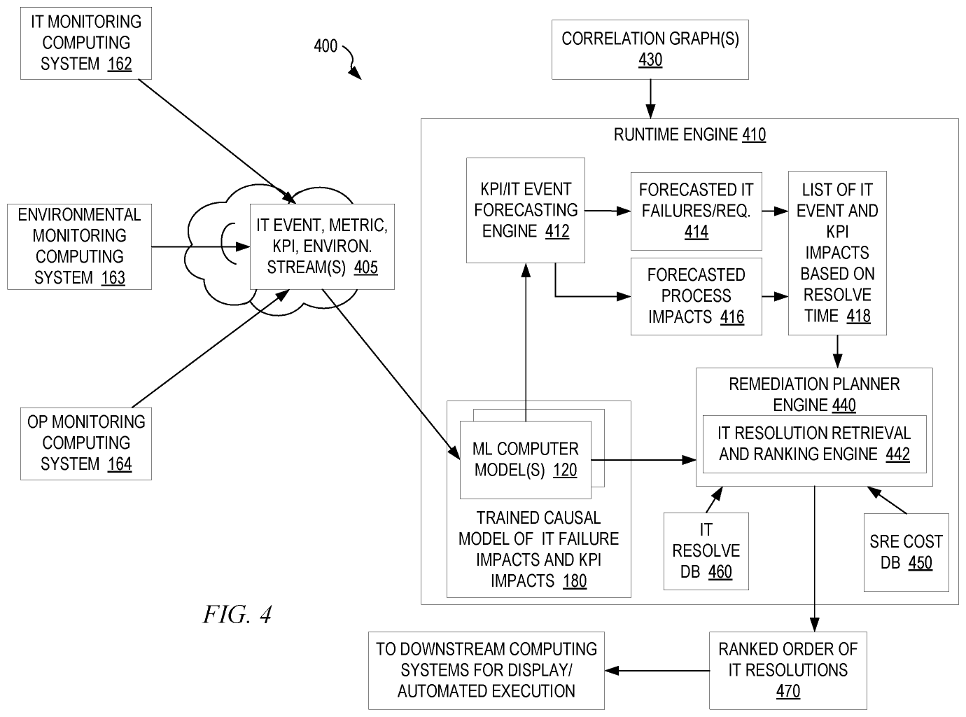

FIG. 4 is an example block diagram illustrating the primary operational components of an OP-IT forecasting computing system during online operations in accordance with one illustrative embodiment. It should be appreciated that the OP-IT forecasting computing system 400 in FIG. 4 assumes a training of ML computer models and generation of correlation graph data structures in accordance with one or more of the illustrative embodiments, such as described previously with regard to FIGS. 1-3. Thus, the trained ML computer models 420 may be the ML computer models 120 in FIG. 1, for example, which have been trained on the historical data 160. Similarly, the correlation graphs 430 may be the correlation graphs 130 in FIG. 1 generated by the correlation engine 120 based on the historical data 160, the IT topology 140, and the process model 150.

As shown in FIG. 4, a runtime engine 410 of the OP-IT forecasting computing system 400 receives, as input data, IT event streams, organizational metric/KPI streams, and environmental metrics streams 405. These streams of data may be received from various source computing systems, such as IT monitoring computing system 162, environmental monitoring computing system 163, and/or organizational performance (OP) monitoring computing system 164 in FIG. 1, for example. These streams of data are input to the trained ML computer models 420 and the runtime engine 410. The runtime engine 410 comprises a KPI/IT event forecasting engine 412 comprising logic to take the predications/forecasts generated by the ML computer models 120 based on the input streams 405, and correlate these predications/forecasts with IT computing resources and/or organizational processes and sub-processes using the correlation graph data structures 430. That is, the KPI/IT event forecasting engine 410 identifies the impacted organizational operations and IT computing resources based on the mapping of KPIs to organizational processes and sub-processes, and the mapping of IT events to IT computing resources. The KPI/IT event forecasting engine 410 may generate forecasted IT failures/requirements 414 based on the correlated IT computing resources affected by the predicted/forecasted IT events, and the type of IT events predicted/forecasted. The KPI/IT event forecasting engine 410 also may generate forecasted organization process impacts based on the forecasted KPIs or changes in KPIs. These forecasts 414 and 416 may then be combined by logic of the runtime engine 410 into a combined listing of IT events and KPI impacts based on forecasting time (e.g. 6 hours from now vs. four hours from now).

The impacted organization operations and IT computing resources in the list data structure 418 may then be input to a remediation planner engine 440 that automatically identifies remediation action recommendations and/or automatically initiates and executes remediation actions to mitigate predicted/forecasted unwanted KPIs, changes to KPIs, or IT events. In identifying these remediation actions, the IT resolution retrieval and ranking engine 442 of the remediation planner engine 440 may perform a lookup operation in an IT resolution database 460, e.g., a site reliability engineering (SRE) database, of remedial actions that address different KPI and/or IT events with regard to specific organizational processes and IT events, IT computing resources, and the like, specified in the listing data structure 418. That is, for the KPI impacts and IT events, as well as their corresponding identified organizational processes/sub-processes and IT computing resources, in the listing data structure 418, the IT resolution retrieval and ranking engine 442 of the remediation planner engine 440 performs a lookup operation in the IT resolution database 460 for one or more entries of IT resolutions that match the pattern of these features from the listing data structure 418 for each IT event and/or KPI impact. Scoring logic of the IT resolution retrieval and ranking engine 442 may be used to score the entries that have some measure of matching so as to identify and rank the entries that have a matching characteristic and identify those that most likely match the particular IT events and/or KPI impacts specified in the listing data structure 418, e.g., a highest scoring entry. If a matching entry is not found in the IT resolution database 460, this lack of a matching entry may also be identified and used in generating the ranked order of IT resolutions 470.

Having identified, by the IT resolution retrieval and ranking engine 442, one or more matching entries in the IT resolution database 460 for one or more of the IT events and KPI impacts specified in the listing data structure 418, these remedial actions may be correlated with costs specified in a costs database, also referred to as a SRE cost database, 450. That is, the SRE cost database 450 specifies, for each remedial action in the IT resolution database 460, a corresponding cost, where this cost may be based on resources needed to complete the remedial action, e.g., personnel costs, time and computing resource costs, costs due to unavailability of organizational processes and/or IT computing resources, etc. Thus, for each IT resolution identified by the IT resolution retrieval and ranking engine 442 through the retrieval, scoring, and ranking, which may be a combination of a plurality of remedial actions, a SRE cost retrieval engine 444 of the remediation planner engine 440 may retrieve a corresponding SRE cost by identifying the SRE costs for each remedial action involved in the IT resolution retrieved from the IT resolution database 460 for the one or more IT events and KPI impacts specified in the listing data structure 418.

The predicted impact of the identified remedial actions, or interventions, may be generated using the trained ML computer models 420 to predict the IT events and/or KPIs, or changes in KPIs, and then having the KPI/IT event forecasting engine 412 generate and list in the listing data structure 418, the corresponding IT failures, IT requirements, organizational process impacts, and the like. Thus, these predictions provide an indication of what will occur if there is not remedial action performed, i.e., no IT resolution. Extrapolation logic of the remediation planner engine 440 may extrapolate these predictions/forecasts for a predetermined time period in the future. For example, a linear extrapolation may be used that assumes that the condition will progress along the same line of metrics, KPIs, etc., predicted/forecasted by the ML computer models 420, such as by using a linear regression based analysis.

Similarly, the remediation planner engine 440 may estimate the impact of a remediation action or IT resolution on these same metrics, KPIs, or the like. In some illustrative embodiments, this is done by performing a counterfactual analysis of resolving the IT issue. The counterfactual analysis can be done by simulating the data with the value of IT events that would result when the IT resolution is performed. For example, adding storage space would reset the value of the IT metric “High disk space” to zero. Hence, the input to 412 would have all the other IT and OP KPIs as-is with the exception of IT metrics that would change because of the IT resolution. The impact of the IT metric on the OP KPIs is then evaluated via the ML computer model(s) 120.

For example, a counterfactual analysis by counterfactual analysis logic 446 of the remediation planner engine 440 may evaluate the performance impact, as may be measured by various metrics including the KPIs, on the organizational processes, and the corresponding costs associated with the remedial action or IT resolution. IT resolution ranking logic 448 may then rank the remedial actions/IT resolutions based on their expected performance impact and corresponding costs using any suitable ranking logic. For example, a cost-benefit analysis may be performed by the IT resolution ranking logic 448 to rank remedial actions and IT resolutions based on maximum benefit with minimal cost type analysis. The result is a ranked order of remedial actions and/or IT resolutions 470 that may be output to appropriate authorized personnel, such as IT teams or the like, so that they may prioritize their efforts in resolving issues based on this ranked ordering 470.

In some cases, the remedial actions and/or IT resolutions specified in the ranked ordering 470 may be automatically initiated and executed to address the predicted IT/KPI issues based on the generated remedial action recommendations. For example, the ranked ordering 470 may be output to management systems, such as management computing systems associated with the source computing systems 162-164 in FIG. 1, and those remedial actions and/or IT resolutions that are able to be automatically implemented may be automatically initiated and executed by these management computing systems. For example, the IT resolution database 460, in addition to other characteristics of remedial actions and IT resolutions, may include indicators specifying whether or not the remedial action/IT resolution can be automatically initiated and executed, and may include computer code, pointers to computer code or applications, scripts, and the like, to facilitate automated initiation and execution of the remedial actions/IT resolutions. These indicators, code, scripts, pointers, or the like, may be included in the ranked order 470 that is provided to the management computer systems which may then use these indicators, code, applications, scripts, pointers, or the like, to automatically initiate and execute remedial actions and IT resolutions specified as capable of automatic implementation. In some illustrative embodiments, platforms such as RedHat Ansible or Rundeck, may be used that allow for automated execution of remediations. These tools allow for executing the scripts automatically by linking them to specific IT resolutions in the IT resolution DB 460.

Thus, the illustrative embodiments provide an improved computing tool and improved computing tool operations/functionality that specifically trains one or more machine learning computer models to predict/forecast KPIs, changes in KPIs, and IT events, and correlates these predictions with IT computing resources and organizational performance operations using correlation graph data structures to thereby forecast the impact of such KPIs, changes in KPIs, and IT events on an organization and its IT infrastructure. The illustrative embodiments provide automated computing tools to perform such predications and forecasts and identify remedial action recommendations to address unwanted impacts on the organization and its IT infrastructure. The illustrative embodiments provide automated computing tools to rank such remedial action recommendations and in some cases automatically initiate and execute the relatively highest ranking remedial action recommendations. Moreover, these operations are performed based on machine learning learned correlations between organizational performance operation metrics, such as KPIs, and underlying IT events. The ranking of remedial action recommendations takes into account the predicted benefit to the organization and its IT infrastructure versus the predicted costs so as to prioritize and focus organization and IT resources to those remedial actions that are of the most benefit with least cost.

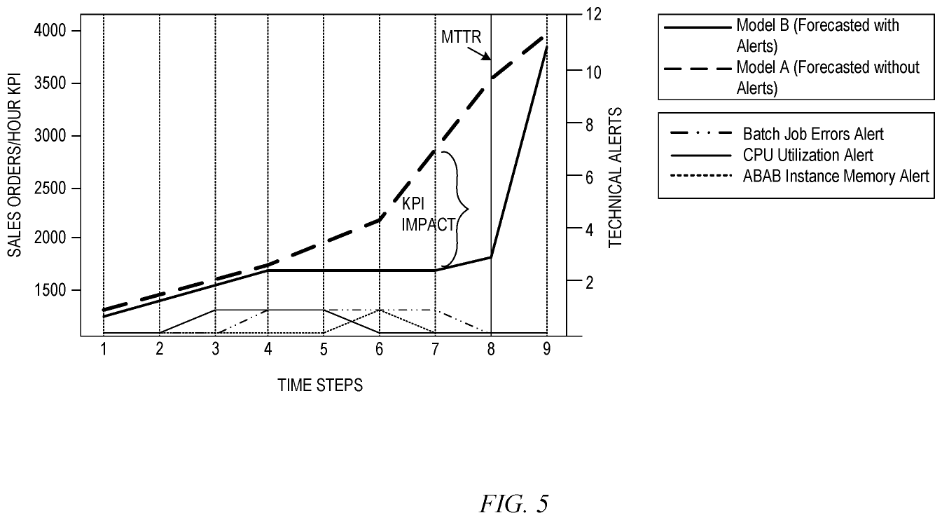

FIG. 5 is an example diagram showing a correlation of OP operation metrics with IT events over time and the determination of a key performance indicator impact based on such a correlation, in accordance with one illustrative embodiment. Here, the model assesses the KPI impact by the counterfactual analysis. The Model B represents the forecast of the KPI given the different IT alerts. At timestep 4, a Batch Job Error alert occurs. As per the model B, the KPI does not increase and remains constant. Model A forecasts the counterfactual KPI value where the Batch Job Error has not occurred. As can be seen in FIG. 5, the forecast of the Model A indicates the KPI constantly increasing. The difference between these two lines: solid (Model B) and dashed (Model A) is the KPI impact at that time step. In this example, the KPI impact is also shown, which can be computed based on the information in an IT resolution DB. If the error takes 4 hours to resolve, this information can be used as input to the model to identify the impact on the KPI.

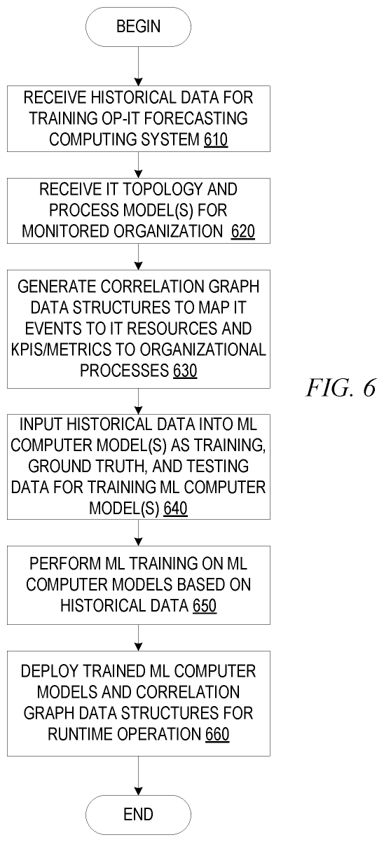

FIGS. 6-8 present flowcharts outlining example operations of elements of the present invention with regard to one or more illustrative embodiments. It should be appreciated that the operations outlined in FIGS. 6-8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 6-8, and may, in some cases, make use of the results generated as a consequence of the operations set forth in FIGS. 6-8, the operations in FIGS. 6-8 themselves are specifically performed by the improved computing tool in an automated manner.

FIG. 6 is a flowchart outlining an example operation for performing offline training of the OP-IT forecasting computing system in accordance with one illustrative embodiment. As shown in FIG. 6, the operation starts by receiving historical data for training the OP-IT forecasting computing system (step 610). This historical data may comprise logs and other data captured by IT monitoring, environmental monitoring, and organizational process monitoring computing systems that operate as data source computing systems for the OP-IT forecasting computing system. In addition to the historical data, the IT topology and process models for the monitored organization and IT infrastructure are obtained (step 620). The historical data, IT topology, and process models are input to the correlation engine(s) which generate correlation graph data structures (step 630). As described above, these correlation graph data structures map IT events to IT computing resources and process metrics and/or KPIs to organizational processes and sub-processes.

The historical data is also input to one or more ML computer models as training data (step 640). A ML training operation is performed on the one or more ML computer models to train the ML computer models to generate predictions/forecasts of IT events and/or KPIs given a pattern of input data representing IT events, process metrics, KPIs, and the like (step 650). For example, a first ML computer model may be trained on such historical data, which may be used to provide training data, ground truth, as well as testing data for the ML training operation, to generate predictions/forecasts of IT events while a second ML computer model may be trained to generate predictions/forecasts of KPIs. The resulting trained ML computer model(s) and correlation graph data structures are deployed for use in evaluating runtime data streams of IT events, metrics, KPIs, and the like (step 660) and the operation terminates.

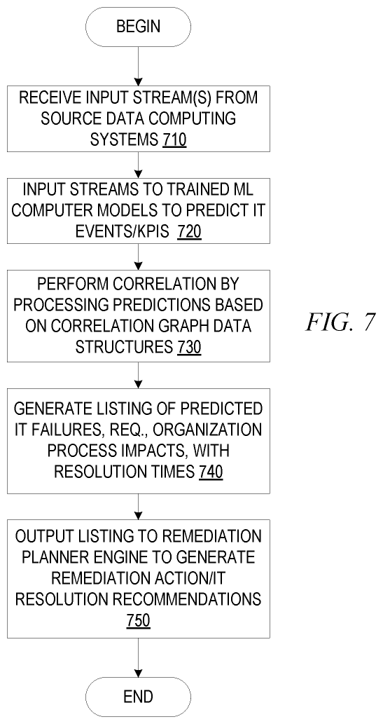

FIG. 7 is a flowchart outlining an example operation for performing online forecasting by way of the OP-IT forecasting computing system in accordance with one illustrative embodiment. The operation outlined in FIG. 7 assumes a training of the OP-IT forecasting computing system components, such as described previously, and also outlined in FIG. 6, for example. The operation starts by receiving one or more input streams of data, such as may represent IT events, organizational process metrics, KPIs, environmental metrics, and the like, from source data computing systems (step 710). These streams of data are input to the trained ML computer model(s) which predict corresponding IT events and KPIs based on the input data and in accordance with their training (step 720). The predicted IT events and KPIs are processed by applying correlation graph data structures to the IT events and KPIs to identify forecasted IT failures, requirements, and organizational process impacts by correlating IT events and KPIs with corresponding IT computing resources and organizational processes and sub-processes (step 730). The forecasted IT failures, requirements, and organization process impacts are compiled into a listing data structure that specifies corresponding the corresponding IT events, IT computing resources affected, organizational processes affected, KPI impacts, and the like, along with corresponding estimated resolution times (step 740). The listing data structure is then output to a remediation planner engine (step 750) to generate remediation action/IT resolution recommendations for output to appropriate authorized personnel, e.g., IT teams, and/or for automated initiation and execution. The operation then terminates.

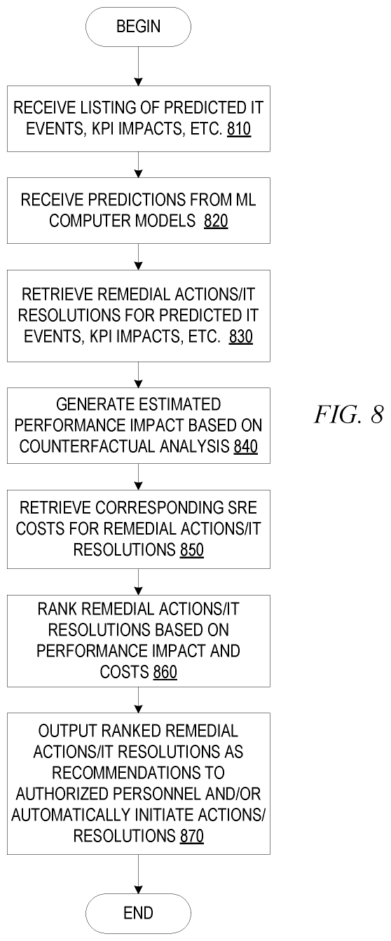

FIG. 8 is a flowchart outlining an example operation for performing remediation action planning based on forecasting from an OP-IT forecasting computing system in accordance with one illustrative embodiment. As shown in FIG. 8, the operation starts by receiving a listing data structure that identifies the IT events, KPI impacts, and the like, as may be generated through the operation of FIG. 7, for example (step 810). In addition, the remediation action planning operation also receives as input, the predictions of IT events and KPIs generated by the ML computer models (step 820). A lookup of the remedial actions and/or IT resolutions corresponding to the IT events and/or KPI impacts is performed to identify, for one or more of the IT events and/or KPI impacts, corresponding remedial actions/IT resolutions that address unwanted conditions (step 830). An estimated performance impact for the remedial actions/IT resolutions is generated, such as by performing a counterfactual analysis (step 840) and corresponding SRE costs are retrieved from an SRE costs database (step 850). The remedial actions/IT resolutions are ranked based on ranking logic, which may implement a cost-benefit analysis based on the SRE costs and estimated performance impacts, for example (step 860). The ranked order of remedial actions/IT resolutions may then be output to authorized personnel, e.g., IT teams, to prioritize application of personnel and IT resources to addressing the IT events that are most impactful on the performance of the organization, such as may be measured by KPIs (step 870). In some cases, although not depicted in FIG. 8, the ranked ordering may also be output for automated initiation and execution of remedial actions/IT resolutions via corresponding monitoring and IT infrastructure management computing systems. The operation then terminates.

From the above discussion, it is clear that the present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an OP-IT forecasting computing system which learns, through machine learning processes, correlations between OP and IT events so that predications/forecasts of the impact of OP and IT events on the OP operations and/or IT computing resources may be automatically generated and remedial actions identified, ranked, and presented to authorized personnel to respond to such predicated/forecasted situations, and in some cases automatically initiated and executed. The improved computing tool implements mechanism and functionality, such as the trained machine learning computer models, correlation graph logic, and the like, of the OP-IT forecasting computer system, which cannot be practically performed by human beings either outside of, or with the assistance of, a technical environment, such as a mental process or the like. The improved computing tool provides a practical application of the methodology at least in that the improved computing tool is able to generate forecasts or predications based on machine learning learned correlations between IT events and OP operation metrics, such as key performance indicators (KPIs), and automatically identify remedial actions to address situations predicted/forecasted based on these learned correlations.

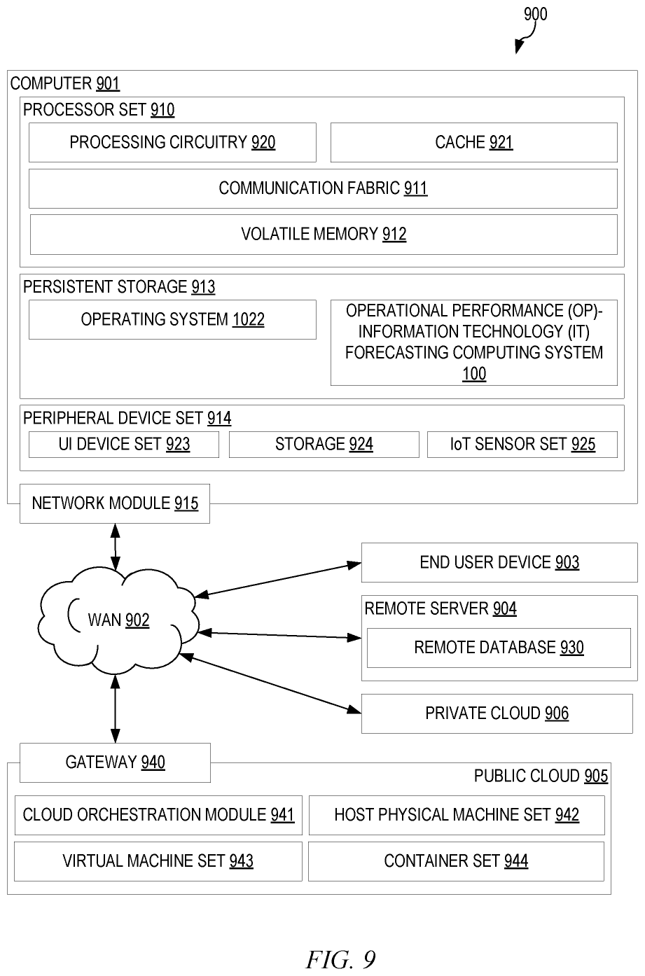

FIG. 9 is an example diagram of a distributed data processing system environment in which aspects of the illustrative embodiments may be implemented and at least some of the computer code involved in performing the inventive methods may be executed. Computing environment 900 contains an example of an environment for the execution of at least some of the computer code involved in performing the inventive methods, such as the OP-IT forecasting computer system 100 in FIGS. 1 and/or 4, i.e., during offline training and/or during online operation. In addition to block 100, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 100, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

Processor set 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 200 in persistent storage 913.

Communication fabric 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

Persistent storage 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 200 typically includes at least some of the computer code involved in performing the inventive methods.

Peripheral device set 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

Network module 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

As shown in FIG. 9, one or more of the computing devices, e.g., computer 901 or remote server 904, may be specifically configured to implement a OP-IT forecasting computing system or computing tool 100, which may operate in accordance with one or more of the illustrative embodiments previously described above. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 901 or remote server 904, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates forecasting IT events and KPI impacts and generating remedial action/IT resolution recommendations based on these forecasted IT events and KPI impacts. These recommendations may then be utilized to focus and prioritize IT resources to those IT events and KPI impacts that will most benefit the organization and provide the optimum benefit versus cost. Moreover, in some cases, the remedial actions and/or IT resolutions may be automatically initiated and executed, if possible.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
executing machine learning training of one or more machine learning (ML) computer models based on historical data representing logged information technology (IT) events and key performance indicators (KPIs) of organizational processes, wherein the one or more ML computer models are trained to forecast at least one of IT events given KPIs in input data, or KPI impact given IT events in the input data;
generating at least one correlation graph data structure that maps at least one of IT events to IT computing resources, or KPI impacts to organizational processes;
processing, by the one or more trained ML computer models, input data to generate a forecast output, wherein the forecast output specifies at least one of a forecasted IT event or a KPI impact;
correlating the forecasted output with at least one of one or more IT computing resources or one or more organizational processes, at least by applying the at least one correlation graph data structure to the forecast output to generate a correlation output; and
generating a remedial action recommendation based on the forecast output and correlation output.

2. The method of claim 1, wherein the at least one correlation graph data structure comprises an organizational process (OP) correlation graph data structure that correlates different types of OP operations with corresponding KPIs, and an IT correlation graph data structure that correlates an IT topology with corresponding IT events.

3. The method of claim 2, wherein applying the at least one correlation graph data structure to the forecast output comprises at least one of:
identifying, in the OP correlation graph data structure, at least one OP operation affected by the forecasted KPI impact; or
identifying, in the IT correlation graph data structure, at least one IT topology component correlated with the forecasted IT event.

4. The method of claim 1, wherein generating a remedial action recommendation comprises performing a lookup operation in a site reliability engineering database of remediation actions corresponding to at least one of the one or more IT computing resources or one or more organizational processes.

5. The method of claim 1, further comprising:
simulating second input data for a remedial action corresponding to the remedial action recommendation; and
processing the second input data by the one or more trained ML computer models to generate a predicted impact outcome of the remedial action on at least one of KPIs or IT events.

6. The method of claim 5, wherein generating the remedial action recommendation comprises identifying a plurality of candidate remedial actions based on the forecast output, and executing the simulation of the second input data and processing of the second input data by the one or more trained ML computer models for each candidate remedial action in the plurality of candidate remedial actions.

7. The method of claim 6, further comprising:
ranking the candidate remedial actions in the plurality of candidate remedial actions relative to one another based on the predicted impact outcomes for each of the candidate remedial actions; and
selecting a candidate remedial action to be a recommended remedial action based on the relative ranking, wherein the remedial action recommendation specifies the selected candidate remedial action.

8. The method of claim 1, further comprising executing a computer simulation employing a counterfactual analysis that simulates different counterfactual conditions not present in the input data and generates corresponding predicted outcomes based on execution of the one or more trained ML computer models on the counterfactual conditions.

9. The method of claim 8, wherein executing the computer simulation employing the counterfactual analysis comprises modifying the input data to the one or more trained ML computer models to represent a return to a normalcy condition for one or more IT metrics and using the one or more trained ML computer models to forecast corresponding KPIs.

10. The method of claim 1, wherein executing the computer simulation employing the counterfactual analysis comprises performing a linear progression on the forecast output to simulate no remediation of forecasted conditions and project the forecasted conditions into future time points.

11. A computer program product comprising a computer readable storage medium having a computer readable program stored therein, wherein the computer readable program, when executed in a data processing system, causes the data processing system to:
execute machine learning training of one or more machine learning (ML) computer models based on historical data representing logged information technology (IT) events and key performance indicators (KPIs) of organizational processes, wherein the one or more ML computer models are trained to forecast at least one of IT events given KPIs in input data, or KPI impact given IT events in the input data;
generate at least one correlation graph data structure that maps at least one of IT events to IT computing resources, or KPI impacts to organizational processes;
process, by the one or more trained ML computer models, input data to generate a forecast output, wherein the forecast output specifies at least one of a forecasted IT event or a KPI impact;
correlate the forecasted output with at least one of one or more IT computing resources or one or more organizational processes, at least by applying the at least one correlation graph data structure to the forecast output to generate a correlation output; and
generate a remedial action recommendation based on the forecast output and correlation output.

12. The computer program product of claim 11, wherein the at least one correlation graph data structure comprises an organizational process (OP) correlation graph data structure that correlates different types of OP operations with corresponding KPIs, and an IT correlation graph data structure that correlates an IT topology with corresponding IT events.

13. The computer program product of claim 12, wherein applying the at least one correlation graph data structure to the forecast output comprises at least one of:
identifying, in the OP correlation graph data structure, at least one OP operation affected by the forecasted KPI impact; or
identifying, in the IT correlation graph data structure, at least one IT topology component correlated with the forecasted IT event.

14. The computer program product of claim 11, wherein generating a remedial action recommendation comprises performing a lookup operation in a site reliability engineering database of remediation actions corresponding to at least one of the one or more IT computing resources or one or more organizational processes.

15. The computer program product of claim 11, wherein the computer readable program further causes the data processing system to:
simulate second input data for a remedial action corresponding to the remedial action recommendation; and
process the second input data by the one or more trained ML computer models to generate a predicted impact outcome of the remedial action on at least one of KPIs or IT events.

16. The computer program product of claim 15, wherein generating the remedial action recommendation comprises identifying a plurality of candidate remedial actions based on the forecast output, and executing the simulation of the second input data and processing of the second input data by the one or more trained ML computer models for each candidate remedial action in the plurality of candidate remedial actions.

17. The computer program product of claim 16, wherein the computer readable program further causes the data processing system to:
rank the candidate remedial actions in the plurality of candidate remedial actions relative to one another based on the predicted impact outcomes for each of the candidate remedial actions; and
select a candidate remedial action to be a recommended remedial action based on the relative ranking, wherein the remedial action recommendation specifies the selected candidate remedial action.

18. The computer program product of claim 11, wherein the computer readable program further causes the data processing system to execute a computer simulation employing a counterfactual analysis that simulates different counterfactual conditions not present in the input data and generates corresponding predicted outcomes based on execution of the one or more trained ML computer models on the counterfactual conditions.

19. The computer program product of claim 18, wherein executing the computer simulation employing the counterfactual analysis comprises modifying the input data to the one or more trained ML computer models to represent a return to a normalcy condition for one or more IT metrics and using the one or more trained ML computer models to forecast corresponding KPIs.

20. An apparatus comprising:
at least one processor; and
at least one memory coupled to the at least one processor, wherein the at least one memory comprises instructions which, when executed by the at least one processor, cause the at least one processor to:
execute machine learning training of one or more machine learning (ML) computer models based on historical data representing logged information technology (IT) events and key performance indicators (KPIs) of organizational processes, wherein the one or more ML computer models are trained to forecast at least one of IT events given KPIs in input data, or KPI impact given IT events in the input data;
generate at least one correlation graph data structure that maps at least one of IT events to IT computing resources, or KPI impacts to organizational processes;
process, by the one or more trained ML computer models, input data to generate a forecast output, wherein the forecast output specifies at least one of a forecasted IT event or a KPI impact;
correlate the forecasted output with at least one of one or more IT computing resources or one or more organizational processes, at least by applying the at least one correlation graph data structure to the forecast output to generate a correlation output; and
generate a remedial action recommendation based on the forecast output and correlation output.
